(19) United States
(12) Patent Application Publication
(10) Pub. No.: US 2004/0212992 A1
(43) Pub. Date: Oct. 28, 2004

(54) Construction of the tube-shaped lighting equipment

(76) Inventor: W. T. Chen, Hsinchu (TW)

Correspondence Address: McGLEW AND TUTTLE, P.C., SCARBOROUGH STATION, SCARBOROUGH, NY, 10510-0827, US

(21) Appl. No.: 10/420,188

(22) Filed: Apr. 22, 2003

(51) Int. Cl. F21S 2/00

(52) U.S. Cl. 362/227

(57) ABSTRACT

Disclosed is an improved tube-shaped lighting equipment to be hung on the grass, doors and windows, and Christmas trees etc., which is composed of lighting elements, an inner insulator and an outer insulator, said lighting elements can rapidly be positioned and fixed in the inner insulator, while the outer insulator encloses the inner insulator together with the lighting elements and a plurality of longitudinal openings can be formed so as to enhance its light reflection effect with strong construction and the property of not easily breakable.

### BACKGROUND OF THE INVENTION

1. Field of the Invention

The present invention relates to a tube-shaped lighting equipment, and more particularly, to a tube-shaped lighting equipment with strong construction and the property of not easily breakable so that it can enhance the reflection and refraction effect of light and can mutually change its combination to create a variety of shapes, thus giving a very good decorative effect.

2. Description of the Prior Art

Commonly used decorative lighting elements are composed of lamp bulbs, burners, or lamp holders and a plurality of wires, which can be encircled into circuits in single or multiple wires. The decorative light elements are hung on places such as the grass, doors and windows, and Christmas trees. This type of decorative lighting equipment is easily breakable when they are transported. Moreover, it is easy for the wires to be knotted so that it is not easy to achieve such an ideal effect when it is used.

Aiming at the aforesaid shortcomings, the present inventor has been endeavoring for a long time intensified research and experimentation to find out the solution and finally has come to the realization of the present invention.

### SUMMARY OF THE INVENTION

For rectifying the aforesaid disadvantages inherent to the conventional technique for tube-shaped lighting equipment, it is an object of the present invention to provide an improved tube-shaped lighting equipment with strong construction and the property of not easily breakable so that it can enhance the reflection and refraction effect of light and can mutually change its combination to create a variety of shapes, thus giving a very good decorative effect.

To achieve the above-mentioned object of the present invention, it is intended to provide an improved tube-shaped lighting equipment, which is characterized in composing of a string of lighting elements, an inner insulator and an outer insulator wherein the lighting elements are installed and fixed on the inner insulator whereas the outer insulator encloses and seals the inner insulator and the plurality of lighting elements therein, and longitudinal spaces are formed in the outer insulator so as to enhance the reflection and refraction effect of light.

To achieve the above-mentioned object in the tube-shaped lighting equipment of the present invention, the string of lighting elements composes of a plurality of wires and illuminators electrically coupled together.

To achieve the above-mentioned object in the tube-shaped lighting equipment of the present invention, said illuminators can be made up of vacuum light bulbs or gas light bulbs or LEDs.

To achieve the above-mentioned object in the tube-shaped lighting equipment of the present invention, the inner insulator can be modeled from transparent, translucent, or colored soft plastics and wherein space is reserved in its center part for the lighting elements to be inserted; moreover, the surface of the inner insulator can be opened and positioned inside the outer insulator so that the combination is easy.

To achieve the above-mentioned object in the tube-shaped lighting equipment of the present invention, the illuminators and some of the wires are enclosed in the reserved space of the inner insulator, and some of the electric wires are positioned beforehand in the insulating plastics for sealing and fixing so as to reduce the occurrence of interrupted-circuits of wires due to damages.

To achieve the above-mentioned object in the tube-shaped lighting equipment of the present invention, the outer insulator can be modeled from transparent, translucent, or colored soft plastics, it encloses and seals the inner insulator and the string of lighting elements therein; moreover, the outer insulator and the inner insulator can be of the same color or of different color, thus enhancing the variability of the tube-shaped lighting equipment.

To achieve the above-mentioned object in the tube-shaped lighting equipment of the present invention, the outer insulator can even form multiple longitudinal spaces of which cross-sections can be in the shape of circles, triangles, ovals or trapeziums or any shape so as to make the tube-shaped lighting equipment more variable.

To achieve the above-mentioned object in the tube-shaped lighting equipment of the present invention, the longitudinal spaces of the outer insulator can be filled in with liquids, colored transparent substances, and light-reflecting substances so as to enhance its special effect.

According to the tube-shaped lighting equipment specified in this invention, the construction is strong and is not easily breakable, and the combination is easy and variable so that this can enhance the reflection and refraction effect of light and can also mutually change its combination into a variety of shapes so as to enhance its decorative effect.

A more complete understanding of these and other features and advantages of the present invention will become apparent from a careful consideration of the following detailed description of certain embodiments illustrated in the accompanying drawings.

### BRIEF DESCRIPTION OF THE DRAWINGS

FIG. 1A is an illustration of the longitudinal cross-section of the construction of the tube-shaped lighting equipment of the present invention;

FIG. 1B is a cross-sectional view seeing from A-A of FIG. 1A.

FIG. 1C is a cross-sectional view seeing from B-B of FIG. 1A.

FIG. 2 is a cross-sectional view of the inner insulator and the outer insulator of the tube-shaped lighting equipment of the present invention in combination; wherein,

FIG. 2A is a cross-sectional view of the inner insulator, and FIG. 2B is a view showing the location of the inner insulator in FIG. 2A of the outer insulator.

FIG. 3 is an illustration of the construction of the tube-shaped lighting equipment of the present invention showing another embodiment of the inner insulator and the outer insulator; wherein FIG. 3A is a cross-sectional view of the inner insulator, and FIG. 3B is a view showing the location of the inner insulator in FIG. 3A of the outer insulator.

FIG. 4A is an illustration of another embodiment of the tube-shaped lighting equipment of the present invention.

FIG. 4B is a cross-sectional view seeing from C-C of FIG. 4A.

FIG. 5 is a perspective view of another embodiment of the inner insulator specified in the tube-shaped lighting equipment of the present invention.

FIG. 6 is an embodiment of the inner insulator specified in FIG. 5 of the tube-shaped lighting equipment of present invention; wherein,

FIG. 6A is a longitudinal cross-sectional view of the invention.

FIG. 6B is a cross-sectional view seeing from A-A line in FIG. 6A.

FIG. 6C is a cross-sectional view seeing from B-B line in FIG. 6A.

### DETAILED DESCRIPTION OF THE PREFERRED EMBODIMENT

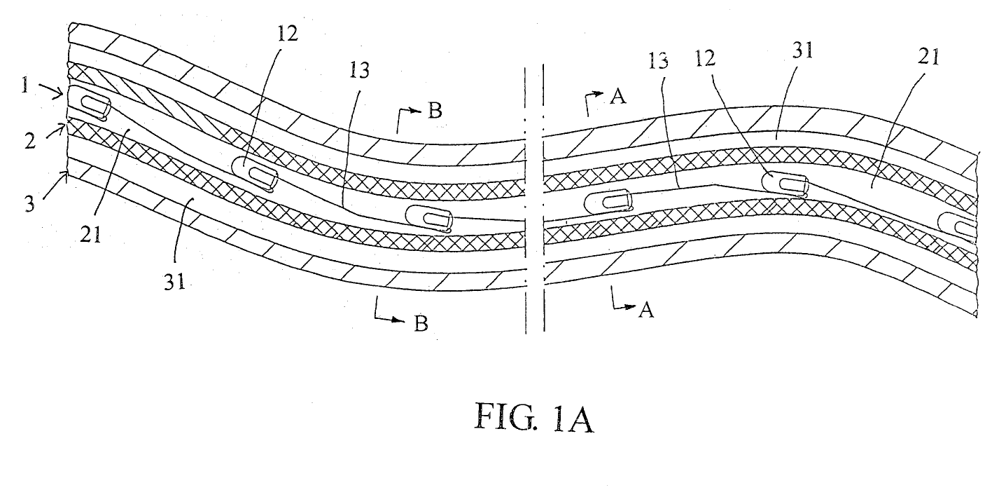

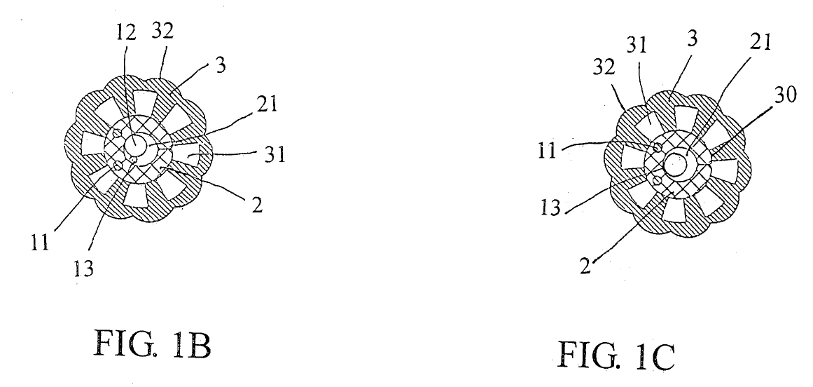

Referring to FIG. 1A, FIG. 1B, and FIG. 1C, the tube-shaped lighting equipment specified in the present invention includes: a string of lighting elements 1, which are composed of wires 13 and illuminators 12; an inner insulator 2 made of transparent, translucent, or colored soft plastics having longitudinal spaces 21 for holding lighting elements 1, wires 11, and illuminators 12; an outer insulator 3 is a hollow shaped to be used to seal the inner insulator 2 and the lighting elements 1 enclosed therein, and longitudinal spaces 31 are formed inside the outer insulator so as to enhance the light reflective and refractive effect of the illuminators 12. The inner insulator 2 inserted in the longitudinal hollow of the outer insulator 3 installed with single or multiple wires 13, and it has a longitudinal opening to be opened to install the lighting elements 1 or illuminators 12. FIG. 1B shows the string of illuminators 12 and the wire 11 are installed in the longitudinal opening 21 connected to the illuminators 12, which can be vacuum light bulbs or gas light bulbs or LEDs. FIG. 1C shows some conduct wire 11 are reserved in the entity of the inner insulator 2.

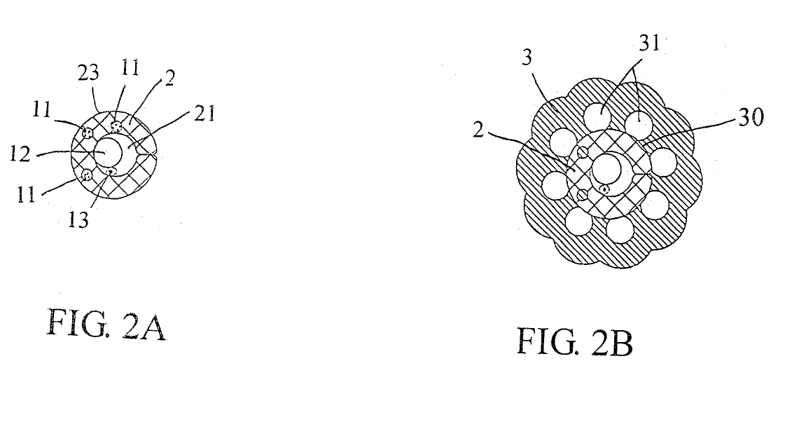

FIG. 2 is the correspondence figure of the cross-sectional view of the outer insulator 3 and the inner insulator 2 of the tube-shaped lighting equipment of the present invention. As shown in FIG. 2A, the inner insulator 2 can be embedded with two or more wires 11 whereas it composes a circular cross section 23, and inside the inner insulator 2 is lined by the longitudinal spaces 21 with a string of lighting elements to be put inside. Moreover FIG. 2B shows that the inner insulator 2 is enclosed in the longitudinal duct 30 of the outer insulator 3 whereas the outer insulator 3 has a circular or an oval-shaped longitudinal space 31.

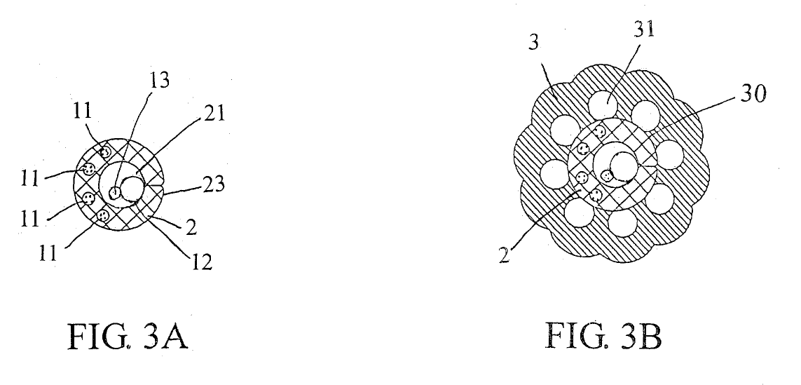

FIG. 3 is another embodiment of the cross-sectional view of the outer insulator 3 and the inner insulator 2 of the tube-shaped lighting equipment of the present invention. As shown in FIG. 3A, the inner insulator 2 can embed three or four wires 11, it is the outer circular cross section 23 can be in the shape of circle, and a longitudinal space 21 is formed inside, and the inner insulator 2 is for holding a string of lighting elements including the wires 13 and illuminators 12. Moreover FIG. 3B shows that the inner insulator 2 is enclosed in the longitudinal duct 30 of the outer insulator 3 whereas the outer insulator 3 has a plurality of circular or an oval-shaped or any shaped longitudinal openings 31.

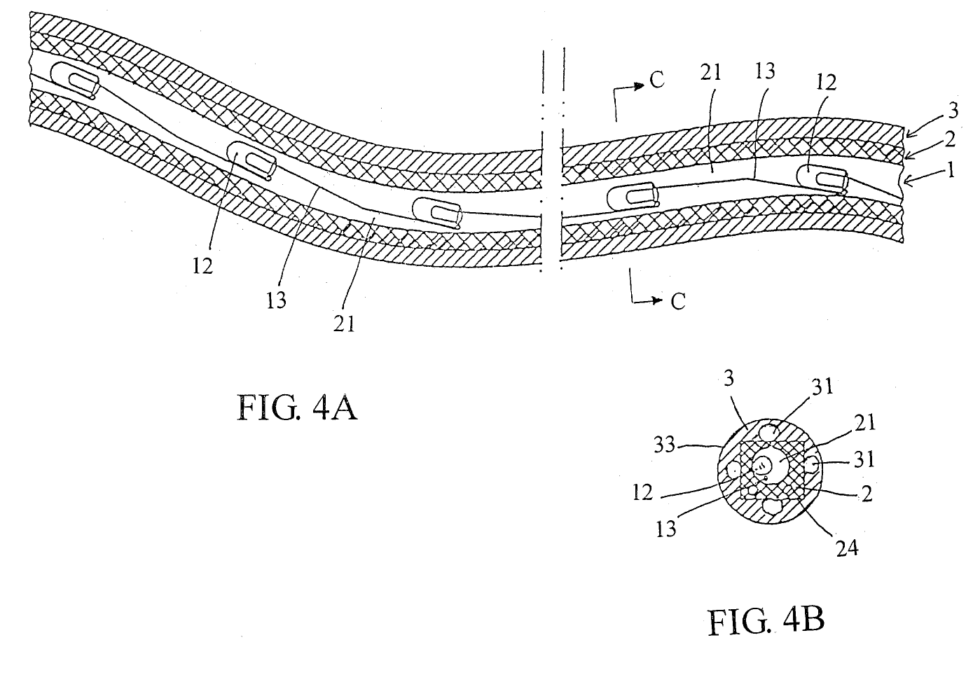

FIG. 4A is another embodiment of the tube-shaped lighting equipment, it is composed of a string of lighting elements 1, including a wire 13 and illuminators 12, an inner insulator 2, and an outer insulator 3; the construction and materials of the inner insulator 2 and the outer insulator 3 are the same as those of FIG. 1. FIG. 4B is a cross-sectional view seeing from line C-C of FIG. 4A, and the outer insulator 3 closely holds the inner insulator 2 together with the string of lighting elements 1 whereas the outer insulator 3 has a circular longitudinal duct 31 and the inner insulator 2 can be in the shape of a trapezium 24, and the longitudinal space 21 has been reserved at the middle parts of the inner insulator 2, so as to be installed with the wire 13 and the illuminator 12 of the lighting elements 1.

The surface of the outer insulator 3 of the invention can be in the shape of waves, circles, rectangles, ovals, and undulations.

Moreover, the inner insulator 2 of the invention can be in the shape of circular, rectangle or oval and etc.

The cross-sections of the plurality of longitudinal spaces 31 formed between the outer insulator 3 and the inner insulator 2 can be in the shape of circles, rectangles, triangles, trapeziums, ovals, or any other shapes.

The longitudinal openings 31 of the outer insulator 3 can be filled in with liquid insulators such as colored transparent substances.

The illuminators 12 of the invention can be made up of vacuum light bulbs, vacuum light bulbs or gas light bulbs or LEDs.

The outer insulator 3 and the inner insulator 2 of the invention can be modeled from transparent, translucent, or color soft plastics.

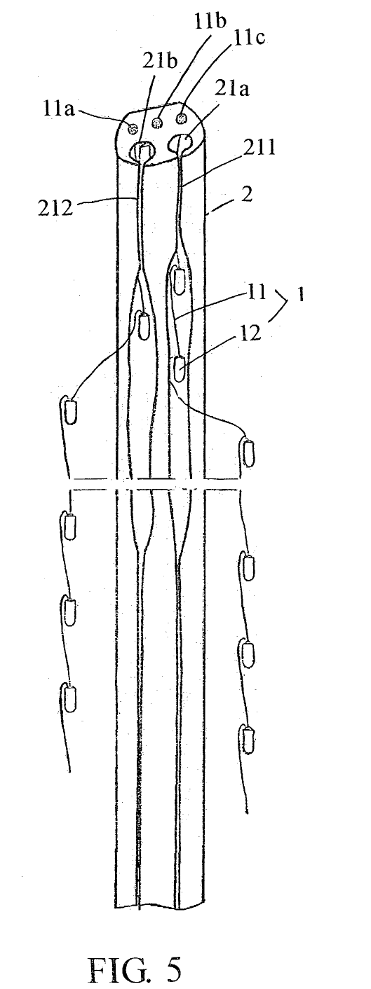

As shown in FIG. 5, the inner insulator 2 of the tube-shaped lighting equipment of present invention can be modeled by transparent or translucent or colored soft plastics wherein the longitudinal spaces of the two ducts, 21a and 21b, are formed on the inner inside of the inner insulator 2; each of the walls of the longitudinal spaces 21a and 21b are formed with small longitudinal openings 211, 212, such that it can be opened to facilitate them for being positioned into the string of lighting elements 1 composed of the wires and illuminators 12. A plurality of wires 11a, 11b, and 11c also can be embedded in the inner insulator 2.

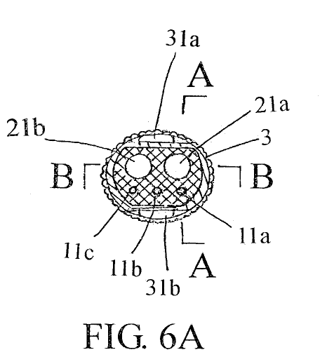

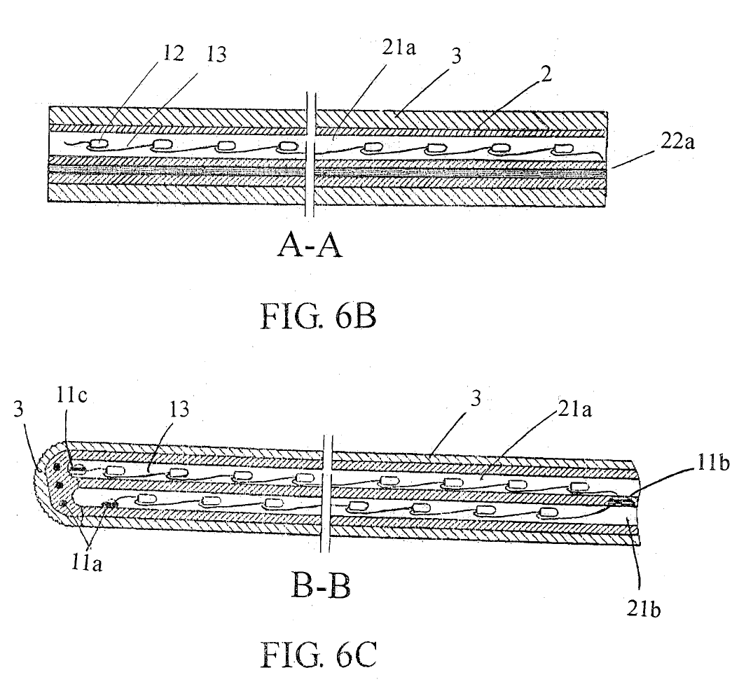

As shown in FIG. 6, after the inner insulator 2 is installed with the string of lighting elements 1 and the two ends of the wire 13 of the lighting elements 1 are connected with pairs of the wires 11a, 11b, and 11c of the inner insulator 2 so as to form the current loop of the lighting equipment 1. Then the inner insulator 2 of the lighting equipment 1 can rapidly be inserted into the outer insulator 3 whereas the outer insulator can be with a longitudinal opening 31a or 31b (as what has been shown in FIG. 6A) or can be without a longitudinal opening (as what has been shown in FIG. 6C.)

For the tube-shaped lighting equipment mentioned in the present invention, because the string of lighting elements 1 can be positioned in the longitudinal spaces 21a, 221b of the opened inner insulator 2. Then the outer insulator 3 is positioned outside the inner insulator 2 so that it is not difficult to position the lighting elements 1 into the outer insulator 3 of the string of lighting elements. Moreover a plurality of liquid insulators can be filled into the longitudinal openings 31 of the outer insulator 3 such as colored transparent substances, luminous plates and etc. to make them more variable. Consequently the subject application, without question, is an invention of practicality and has not been publicly used so that it is deemed as an invention of novelty.

While the present invention has been particularly shown and described with reference to a particular embodiment thereof, it will be understood by those skilled in the art that various changes in form and detail may be effected therein without departing from the spirit and scope of the invention as defined by the appended claims.

What is claimed is:

1. A tube-shaped lighting equipment, characterized in that: it includes a string of lighting elements, an inner insulator and an outer insulator; said lighting elements are put in the inner insulator, while said outer insulator encloses and seals said inner insulator together with said lighting elements.

2. The tube-shaped lighting equipment as claimed in claim 1, wherein said lighting elements are formed by a plurality of wires and illuminators electrically coupled.

3. The tube-shaped lighting equipment as claimed in claim 2, wherein said illuminators are vacuum light bulbs, or gas light bulbs, or LEDs.

4. The tube-shaped lighting equipment as claimed in claim 1, wherein said inner insulator can be made by transparent, translucent or colored soft plastics, and longitudinal space(s) is reserved in the middle and the walls of said longitudinal space(s) to form a longitudinal opening so as to facilitate the opening of said space(s) and the positioning of said string of lighting elements.

5. The tube-shaped lighting equipment as claimed in claim 4, wherein said inner insulator is embedded with longitudinal electric wires to be connected with the wires of said lighting elements to form a loop of electric circuit.

6. The tube-shaped lighting equipment as claimed in claim 1, wherein said outer insulator is a pipe modeled from transparent, translucent, or colored soft plastics and encloses said inner insulator together with said lighting equipment.

7. The tube-shaped lighting equipment as claimed in claim 6, wherein a plurality of longitudinal openings are formed in said outer insulator.

8. The tube-shaped lighting equipment as claimed in claim 7, wherein said longitudinal openings of said outer insulator are filled with liquid insulators.

9. The tube-shaped lighting equipment as claimed in claim 8, wherein said liquid insulators are made of colored transparent substances.
